(19) United States
(12) Patent Application Publication
(10) Pub. No.: US 2012/0131766 A1
(43) Pub. Date: May 31, 2012

(54) Sheet Wafer Defect Mitigation

(75) Inventors: Leo van Glabbeek, Franklin, MA (US); Gerald A. Simpson, JR., Auburn, MA (US); Soumana Hamma, Shrewsbury, MA (US); Stephen Yamartino, Wayland, MA (US)

(73) Assignee: Max Era, Inc., Marlborough, MA (US)

(21) Appl. No.: 13/249,742

(22) Filed: Sep. 30, 2011

Related U.S. Application Data
(60) Provisional application No. 61/388,924, filed on Oct. 1, 2010.

(51) Int. Cl. B01D 9/00; B01J 19/00; C03B 33/00

(52) U.S. Cl. 23/295 R; 65/160; 422/119

(57) ABSTRACT

A method of forming a sheet wafer melts feedstock material in a crucible that is part of a crystal growth furnace, and passes a plurality of filaments through the crucible to form a (un-separated) sheet wafers. A plurality of sheet wafers may be formed in different lanes in the crucible. One or more vision systems is used, during growth, to determine if a sheet wafer has a defective condition. If a defect is detected, then any of a variety of corrective actions may be taken, such as activating a cutting device to remove at least a portion of the sheet wafer, assessing the defect and grading a portion of the sheet wafer (e.g., for sorting based on grade), and/or producing an indicia. In a multiple-lane embodiment, a defect may be attended to in one lane while sheet growth continues in one or more other lanes.

### CROSS-REFERENCE TO RELATED APPLICATION(S)

This patent application claims the benefit of U.S. Provisional Patent Application No. 61/388,924 entitled METHOD OF MITIGATING DEFECTS WHILE FORMING A SHEET WAFER filed on Oct. 1, 2010, which is hereby incorporated herein by reference in its entirety.

### TECHNICAL FIELD

The invention generally relates to sheet wafers and, more particularly, the invention relates to fabrication of sheet wafers.

### BACKGROUND ART

Silicon wafers are the building blocks of a wide variety of semiconductor devices, such as solar cells, integrated circuits, and MEMS devices. For example, Evergreen Solar, Inc. of Marlboro, Mass. forms solar cells from silicon sheet wafers fabricated by passing two filaments through a crucible of silicon melt.

Continuous growth of silicon sheets eliminates the need for slicing of bulk produced silicon to form wafers. Two filaments of high temperature material are introduced up through the bottom of a crucible which includes a shallow layer of molten silicon, known as a “melt.” A seed is lowered into the melt, connected to the two filaments, and then pulled vertically upward from the melt. A meniscus forms at the interface between the bottom end of the seed and the melt, and the molten silicon freezes into a solid sheet just above the melt. The filaments serve to stabilize the edges of the growing sheet. U.S. Pat. No. 7,507,291, which is incorporated herein by reference in its entirety, describes a method for growing multiple filament-stabilized crystalline sheets simultaneously in a single crucible. Each sheet grows in a “lane” in the multi-lane furnace. The cost of fabricating wafers is thus reduced compared to crystalline sheet fabrication in a single-lane furnace.

Undesirably, like other wafer fabrication technologies, this wafer fabrication technique can produce defective wafers. For example, the wafers can have a bow, a chip, a crack, a break, a bulge, and/or other defects. In an attempt to detect defects, an operator may briefly visually inspect some of the wafers before they are sent to a higher level, downstream process. Dozens of furnaces in a factory, however, can produce thousands of wafers every hour. The operators thus have limited time and resources to inspect every wafer.

This deficiency can result in large batches of defective wafers, which may be integrated into products produced downstream in a device fabrication process. For example, a furnace could produce defective wafers for forty-eight hours. Those wafers could be processed into solar cells and assembled into solar panels. These downstream panels thus often are less efficient and, sometimes, not usable.

### SUMMARY OF EXEMPLARY EMBODIMENTS

In accordance with one aspect of the invention, a method of forming a sheet wafer melts feedstock material in a crucible that is part of a crystal growth furnace, and passes a plurality of filaments through the crucible to form a plurality of (un-separated) sheet wafers. Each sheet wafer is formed in a different lane in the crucible. The method uses vision systems, during growth, to determine if any of the plurality of sheet wafers has a defective condition. If the vision systems detect a defect, then removal logic of the furnace causes removal of the defective condition from a defective sheet wafer.

The method also may produce some indicia if the vision systems detect a defect. The indicia may be any one or more of a visual indicia (e.g., a light) and audio indicia (e.g., an alarm). In some embodiments, the defective sheet wafer has a defective portion and a non-defective portion. In that case, the method may remove the defective portion, only leaving the non-defective portion behind. The defective condition may be at least one of a bow, a chip, a crack, a break, and a bulge. The method can continue sheet wafer growth of the defective sheet wafer while removing the defective condition (e.g., the defective portion).

In some instances, the defective sheet wafer may be located in one of the plurality of lanes. The method may continue sheet wafer growth of a sheet wafer in another lane while removing the defective condition from the defective sheet wafer. If the defective sheet wafer is located in one of the plurality of lanes, then the removing logic may cause removal of the entire defective sheet wafer from the one lane and then re-seed a new sheet wafer in that one lane.

The feedstock can be any of a number of different types of materials commonly used to form sheet wafers, such as polysilicon. Moreover, the removal logic may be integrated into the crystal growth furnace, or be a separate component that is coupled with the furnace.

Illustrative embodiments of the invention may be implemented, at least in part, as a computer program product having a computer usable medium with computer readable program code thereon. The computer readable code may be read and utilized by a computer system in accordance with conventional processes.

Thus, embodiments of the present invention may include a method of forming wafer products from a sheet wafer including melting feedstock material in a crucible that is part of a crystal growth furnace; passing a plurality of filaments through the crucible to form a sheet wafer; determining whether a portion of the sheet wafer is defective using an electronic vision system; and if the portion is deemed to be defective, producing an output signal indicating that the portion is defective.

Embodiments of the present invention also may include a sheet wafer growth furnace system including a crucible configured to contain melted feedstock, the crucible having a plurality of holes for passing a plurality of filaments through melted feedstock to form a sheet wafer; an electronic vision system for producing digital images of a portion of the sheet wafer; and a controller in communication with the electronic vision system for at least determining whether a portion of the sheet wafer is defective based on the digital images and producing an output signal if the portion is deemed to be defective.

In various alternative embodiments, the portion may be determined to be defective based on such things as a defect type for at least one defect in the portion (e.g., a bow, a chip, a crack, a break, and a bulge), a defect size for at least one defect in the portion, a defect location for at least one defect in the portion (e.g., based on the distance of the defect from at least one edge of the portion), a defect severity for at least one defect in the portion, a boundary for at least one defect in the portion, and/or the number of defects within the portion. The vision system may include a camera for capturing an image of at least the portion of the sheet wafer. Additionally or alternatively, the vision system may include a sensor for detecting a bow in the portion of the sheet wafer (e.g., a separate camera or other sensor such as a photoelectric eye type device, laser scanner, etc.).

In further embodiments, in response to the output signal, a cutting device may be activated to cause removal of the portion from the sheet wafer. The cutting device may include, for example, a laser. The furnace may be a multiple-lane furnace with the above-mentioned sheet wafer in one lane of the furnace, and sheet wafer growth may continue in at least one other lane while the portion is removed from the sheet wafer. Additionally or alternatively to causing removal of the portion from the sheet wafer, in response to the output signal, a level of defectiveness of the portion may be assessed and the portion may be graded based on the level of defectiveness, and the portion may be sorted based on the grade. Additionally or alternatively to causing removal of the portion and/or assessing/grading the portion, an indicia (e.g., a visual indicia, an audio indicia, and/or an electronic message) may be produced in response to the output signal.

Additional embodiments may be disclosed and claimed.

### BRIEF DESCRIPTION OF THE DRAWINGS

Those skilled in the art should more fully appreciate advantages of various embodiments of the invention from the following “Detailed Description of Illustrative Embodiments,” discussed with reference to the drawings summarized immediately below.

FIG. 1A schematically shows a sheet wafer having a variety of different defects that illustrative embodiments can remove.

FIG. 1B schematically shows a side view of a sheet wafer that undesirably is bowed.

FIG. 2 schematically shows a crucible growing a plurality of sheet wafers.

FIG. 3 schematically shows a furnace that can incorporate the crucible shown in FIG. 2. This furnace incorporates illustrative embodiments of the invention.

FIG. 4 shows a process of forming sheet wafers in accordance with illustrative embodiments of the invention.

FIG. 5 schematically shows an exemplary system having a camera focused on a front surface of the sheet wafer as well as a camera that monitors the sheet wafer from above.

FIG. 6 schematically shows a progression of cuts by which defective portions are removed from the sheet wafer, in accordance with illustrative embodiments of the present invention.

It should be noted that the foregoing figures and the elements depicted therein are not necessarily drawn to consistent scale or to any scale. Unless the context otherwise suggests, like elements are indicated by like numerals.

### DETAILED DESCRIPTION OF ILLUSTRATIVE EMBODIMENTS

In illustrative embodiments, a multi-lane furnace simultaneously forms multiple sheet wafers in a manner that mitigates defects. To that end, the furnace has an apparatus with logic for detecting and removing wafer defects from a wafer growing in one lane without interrupting wafer growth in the other lane(s). Details of illustrative embodiments are discussed below.

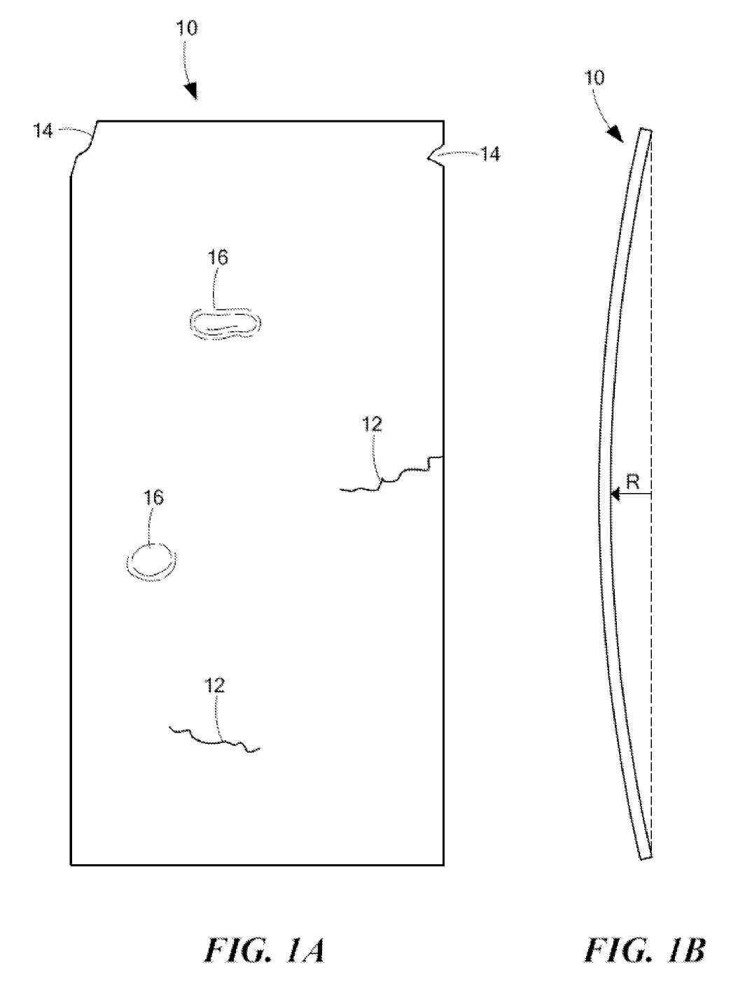

FIGS. 1A and 1B schematically show two examples of defective sheet wafers 10. In a manner similar to other sheet wafers 10, these sheet wafers 10 each has a generally rectangular shape and a relatively large surface area on its front and back faces. For example, the sheet wafer 10 may have a width of about 3 inches, and a length of 6 inches. The thickness of the sheet wafer 10 varies and is very thin (e.g., between 190 microns and 195 microns) relative to its length and width dimensions.

As an example, the sheet wafer 10 may be similar to the STRING RIBBON™ sheet wafers 10 produced by Evergreen Solar, Inc. of Marlborough, Mass., which are used to form photovoltaic cells. Those sheet wafers have polysilicon bodies generally bounded on their edges by a pair of high temperature filaments.

As known by those skilled in the art, however, sheet wafers 10 are very fragile. In fact, many conventional processes undesirably fabricate sheet wafers 10 that can include various types of defects. FIGS. 1A and 1B schematically show examples of such defects. Specifically, FIG. 1A schematically shows a sheet wafer 10 having cracks 12, chips 14 along its periphery, and random bulges 16 along its face. In a corresponding manner, FIG. 1B schematically shows a side view of a sheet wafer 10 that is not flat—instead, it undesirably has a radius of curvature R.

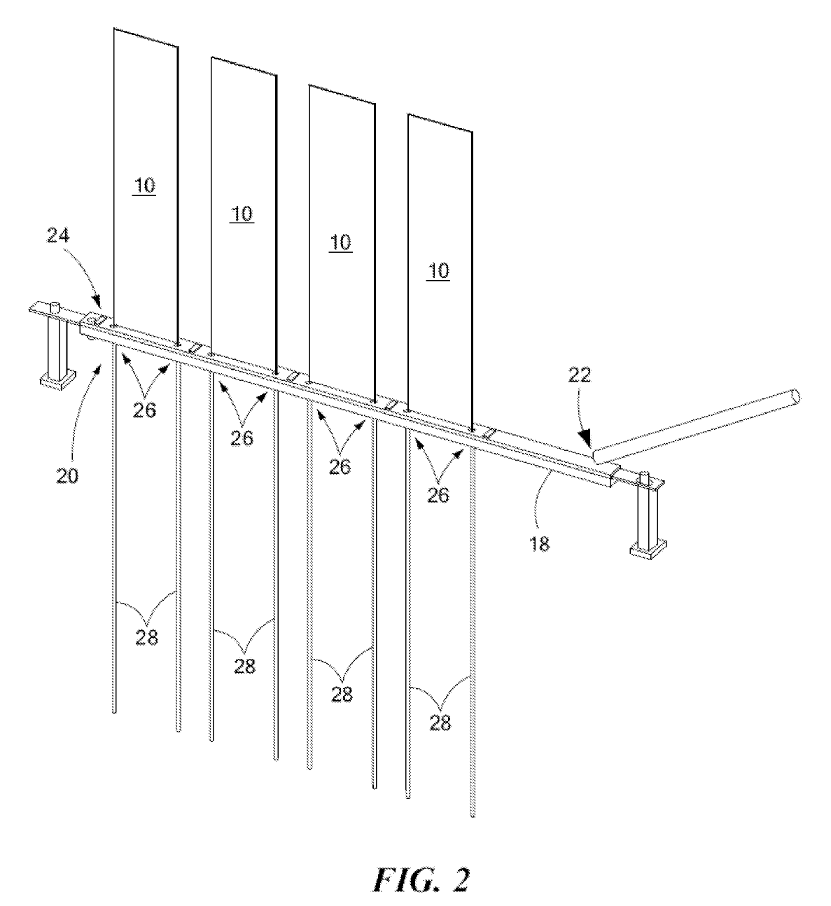

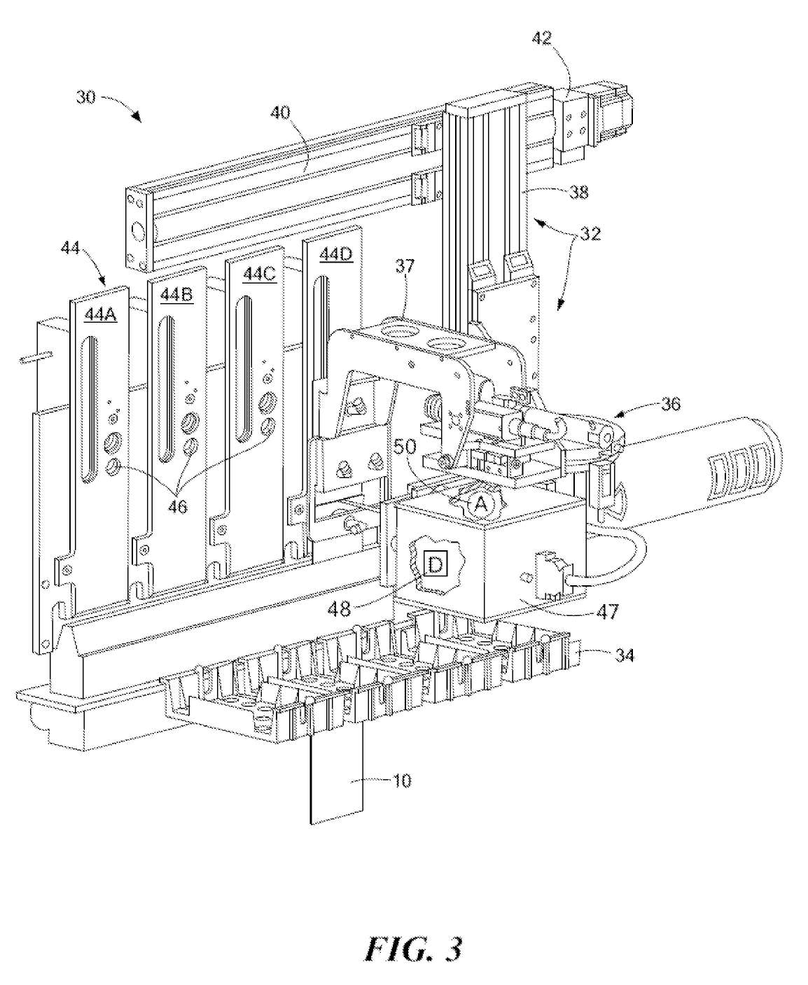

Illustrative embodiments mitigate these defects by removing at least some of the defects during the wafer growth process, notifying an operator of the defects during the growth process, or both. To those ends, FIG. 2 schematically shows a multi-lane crucible 18 growing four sheet wafers 10, while FIG. 3 schematically shows a larger system that incorporates the crucible 18 of FIG. 2 and has an apparatus with logic for removing wafer defects.

As shown in FIG. 2, this embodiment of the crucible 18 has an elongated shape with a region for growing silicon sheet wafers 10 in a side-by-side arrangement along its length.

The crucible 18 of FIG. 2 is formed from graphite and is resistively heated to a temperature capable of maintaining silicon above its melting point. To improve results, the crucible 18 typically has a length that is much greater than its width. For example, the length of the crucible 18 may be three or more times greater than its width. Of course, in some embodiments, the crucible 18 is not elongated in this manner. For example, the crucible 18 may have a somewhat square shape, or a nonrectangular shape.

As shown, the crucible 18 has a feed inlet portion 22 for receiving polysilicon or other feedstock, a growth region 20 for growing four sheet wafers 10, and a melt dump region 24 for removing the melt. In addition, the crucible 18 has four pairs of filament openings 26, within the growth region 20, for receiving four pairs of filaments 28. Each pair of filaments 28 passes through the melted silicon in a controlled manner to form a growing sheet wafer 10. As discussed below, automated, computerized processes cut the growing sheet wafers 10 into smaller sheet wafers 10 as they move upwardly.

The crucible 18 is used as part of a process within a larger sheet wafer growth furnace 30, such as that shown in FIG. 3. For simplicity, the molten material discussed herein may be molten silicon. Of course, various embodiments of the invention may be applied to other molten materials. Moreover, those skilled in the art should understand that principles of various embodiments apply to furnaces that process more or fewer than four separate sheet wafers 10 and therefore can apply to furnaces having one or more lanes and/or to individual lanes of a multiple-lane furnace. For example, some embodiments apply to furnaces growing two sheet wafers 10 or six sheet wafers 10. Accordingly, discussion of a single furnace growing four sheet wafers 10 is for illustrative purposes only.

The furnace 30 has a movable assembly 32 for selectively separating (e.g., cutting) growing sheet wafers 10, and then moving the separated portion (now in smaller wafer form since it is no longer growing), which forms a smaller wafer 10, into a conventional tray 34. For example, the movable assembly 32 may process a first sheet wafer 10 by 1) separating a portion from the first sheet wafer 10 as it grows, and then 2) placing the separated portion in the tray 34. After placing the separated portion of the first sheet wafer 10 in the tray 34, the movable assembly 32 may repeat the same process with a second growing sheet wafer 10. This process may repeat indefinitely between the four growing sheet wafers 10 until some shut down or stoppage event (e.g., to clean the furnace 30 or to fix the furnace 30 after detecting a defective sheet wafer 10). For convenience, the separated portions of sheet wafer may be referred to below as “wafer products” to distinguish them from the larger sheet wafer—generally speaking, it is these wafer products that are integrated into other products such as solar panels.

To perform this function, the movable assembly 32 has, among other things, a separation mechanism/apparatus (e.g., having a laser assembly 36, discussed immediately below) for separating a portion of the sheet wafer 10, and a rotatable robotic arm 37 for grasping both smaller wafers 10 (as they are removed) and growing sheet wafers 10, and positioning the grasped wafers 10 in the tray 34. Consequently, the furnace 30 may substantially continuously produce silicon wafers 10 without interrupting the crystal growth process. Some embodiments, however, can cut the sheet wafers 10 when crystal growth has stopped.

To those ends, the movable assembly 32 also may include a laser assembly 36 that, along with the rest of the movable assembly 32, is vertically movable along a vertical stage 38, and horizontally movable along a horizontal stage 40. Conventional motorized devices, such as stepper motors (one of which is shown and identified by reference number 42), control movement of the movable assembly 32. For example, a vertical stepper motor (not shown) vertically moves the movable assembly 32 as a function of the vertical movement of a growing wafer (discussed in greater detail below). A horizontal stepper motor 42 moves the assembly 32 horizontally. Of course, as noted, other types of motors may be used and thus, discussion of stepper motors is illustrative and not intended to limit all embodiments.

The flexibility afforded by the vertical and horizontal stages 38 and 40 enables the laser assembly 36 to serially cut multiple growing sheet wafers 10. In illustrative embodiments, the vertical and horizontal stages 38 and 40 are formed primarily from aluminum members that are isolated from the silicon, which can be abrasive. Specifically, exposing the stages 38 and 40 to silicon could impair and degrade their functionality. Accordingly, illustrative embodiments seal and pressurize the stages 38 and 40 to isolate them from the silicon in their environment.

The furnace 30 also has guide assembly 44 with four separate guides 44A-44D (i.e., one for each growth channel) for simultaneously growing four separate sheet wafers 10. When referenced individually or collectively without regard to a specific channel, a guide will be generally identified by reference number 44. For illustrative purposes, a single sheet wafer 10 is shown in guide/channel 44D, although typically there would be sheet wafers 10 in each of the guides/channels 44.

Each guide 44, which is formed primarily from graphite, produces a very light vacuum along its face. This vacuum causes the growing sheet wafer 10 to slide gently along the face of the guide 44 to prevent the sheet wafer 10 from drooping forward. To that end, illustrative embodiments provide a port on the face of each guide 44 for generating a Bernoulli vacuum having a pressure on the order of about 1 inch of water.

Each guide 44 also has a wafer detect sensor 46 for detecting when the growing sheet wafer 10 reaches a certain height/length. As discussed below, the detect sensors 46 each produce a signal that controls processing by, and positioning of, the movable assembly 32. Specifically, after detecting that a given sheet wafer 10 has reached a certain height/length, the detect sensor 46 on a given guide 44 monitoring the given sheet wafer 10 forwards a prescribed signal to logic that controls the movable assembly 32. After receipt, the movable assembly 32 should move horizontally to the given guide 44 to produce a smaller wafer 10. Of course, the movable assembly 32 may be delayed if requests from sensors 46 at other guides 44/channels have not been sufficiently serviced.

Many different types of devices may be used to implement the functionality of the detect sensor 46. Vision systems are one type. For example, a retro-reflective sensor, which transmits an optical signal and measures resultant optical reflections, should provide satisfactory results. As another example, an optical sensor having separate transmit and receive ports also may implement the detect sensor functionality. As yet another example, the vision systems may include a low cost line scan camera. Other embodiments may implement non-optical sensors.

The movable assembly 32 therefore moves to the appropriate guide 44 in response to detection by the detect sensor 46. In this manner, the movable assembly 32 is capable of serially processing and cutting the four growing sheet wafers 10. It should be noted that illustrative embodiments apply to other configurations and, as suggested above, to different numbers of guides 44/channels. Discussion of four side-by-side guides 44 thus is for illustrative purposes only. For additional details of various embodiments of the furnace 30, see United States Published Patent Application No. US-2008-0102605-A1 corresponding to co-pending U.S. patent application Ser. No. 11/925,169 (attorney docket number 3253/130), which is incorporated herein, in its entirety, by reference.

The various operations of the furnace, such as monitoring wafer position via the sensors 46 and operating the assembly 32 to cut wafer products from the various lanes, are generally managed by a controller 47 that includes appropriate hardware and/or software logic.

As noted above, in accordance with illustrative embodiments, the furnace 30 has an apparatus for detecting and fixing growing sheet wafers with defects 10. Specifically, the furnace 30 has internal and/or external defect logic 48 (shown here as part of the controller 47) that detects a defect in a growing sheet wafer 10, and takes appropriate action. That appropriate action may include, among other things, cutting the defect from the growing wafer 10 and generating some warning, such as a visual signal or an alarm, alerting the operator to the defects.

To those ends, the furnace 30 has a defect module 48 that detects, through one or more electronic vision systems (e.g., the detect sensors 46, or other sensors), one or more defects, and removes the portion(s) of the growing wafer 10 with the defect. For example, the system may include one or more cameras to monitor the sheet wafers in the various lanes, with appropriate digital processing to detect various types of defects, e.g., as discussed with reference to FIG. 1A above. Cameras may be placed in various positions. Typically, a camera would be focused on a front side of a sheet wafer to monitor for defects. In some embodiments, backlighting or direct lighting of the sheet wafer may be used to improve contrast of the image of the sheet wafer, which may aid in detection of defects. Additionally, another camera may be focused on a back side of the sheet wafer in order to detect defects that are not apparent from the front side. A separate camera or other sensor (e.g., a photoelectric eye type device, laser scanner, etc.) may monitor the sheet wafer, e.g., from the side or top, in order to detect “bowing” as discussed above with reference to FIG. 1B. Thus, the defect logic 48 may include image processing logic to analyze digital images from one or more cameras to detect any of a variety of defects. Generally speaking, the image processing logic would be configured to detect anomalies or characteristics that otherwise would not be present in images of a non-defective sheet wafer, such as the outline of a bow, a chip, a crack, a break, or a bulge.

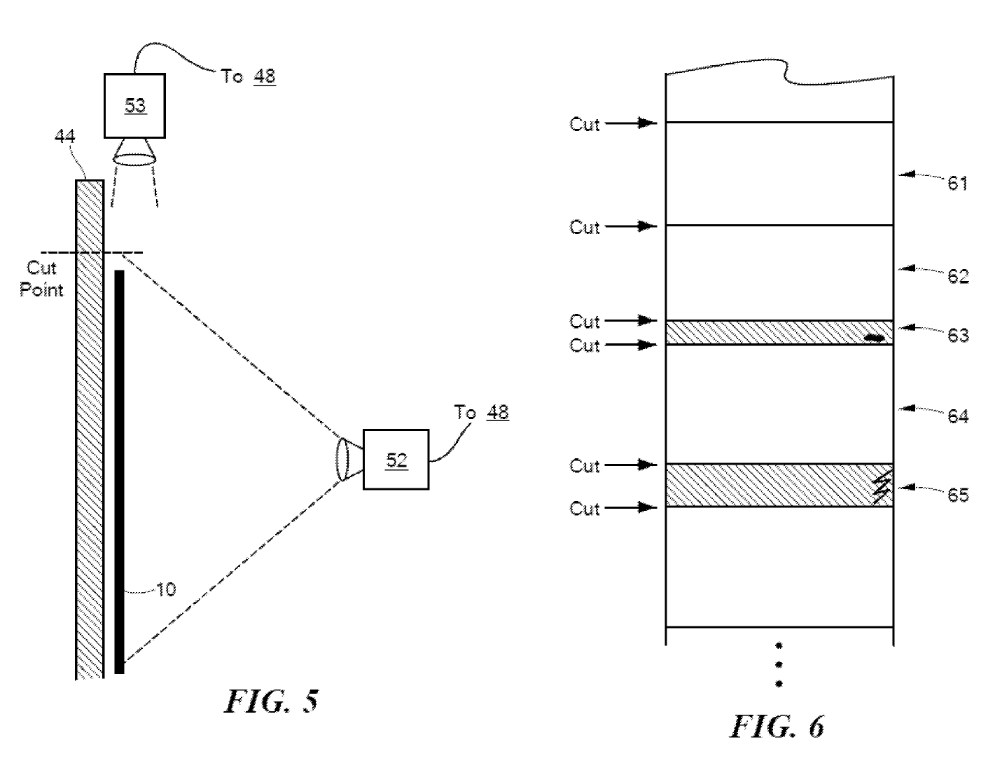

FIG. 5 schematically shows an exemplary system having a camera 52 focused on a front surface of the sheet wafer 10 as well as a camera 53 that monitors the sheet wafer from above. The cameras 52 and 53 send digital image information to the defect logic 48, which detects defects in the sheet wafer as discussed herein.

FIG. 6 schematically shows a progression of cuts by which defective portions are removed from the sheet wafer. In this example, following two acceptable wafer products 61 and 62 were cut from the sheet wafer 10 (noting that an “acceptable” wafer product may include some defects), a small defective portion 63 of the sheet wafer 10 was removed from the sheet wafer 10. Similarly, following another acceptable wafer product 64, another small defective portion 65 was removed from the sheet wafer 10.

The defect logic 48 may detect not only the existence of defect(s) but also characterize such things as the location, number, size, and/or severity of the defect(s) and determine therefrom if and when to remove a defective portion of sheet wafer. For example, the defect logic 48 may selectively remove a defective portion if and only if the portion meets a certain level of defectiveness, e.g., based on such things as the number, size, type, severity, and/or location of the defect(s). Thus, for example, the defect logic 48 may cause removal of a portion having one severe defect or a large number of minor defects but spare a portion that has a few minor defects or a defect in an acceptable area of the sheet wafer (e.g., a defect close to an edge might be acceptable while a defect in the middle might be unacceptable). In assessing the distance of a defect from the edges of the wafer, the defect logic 48 may consider not only the distance from the sides of the wafer (i.e., near the filaments) but also the distance from the top and/or bottom of what will be the final wafer.

In deciding whether/where/when to make a cut to remove a defective portion of sheet wafer, the logic may assess not only the types of defect characteristics mentioned above but also the boundaries of the defect, especially for larger defects such as bubbles or cracks. For example, upon detecting the top of a crack, the logic may wait until it detects the end of the crack before making the cut.

Rather than removing and discarding a portion of sheet wafer containing one or more defect(s), the logic could make an assessment of each wafer product, e.g., just before or just after cutting the wafer product from the larger sheet wafer. In this way, the logic could “grade” the wafer products and sort them into different bins based on grade, e.g., a discard bin, a grade “A” bin, a grade “B” bin, etc. Different grades of wafer products may be usable for different applications. While the tray 34 typically has a bin associated with each lane and the wafer products cut from each lane are typically placed in the corresponding bin, the logic instead could use the bins for sorting purposes, as the robotic arm 37 can be moved from lane-to-lane and therefore could be configured/controlled to allow for moving wafer products from any lane to any bin.

As noted herein, the defect module 48 can attend to defects in a wafer 10 in one lane of a multiple-lane furnace (e.g., detect defects, remove a defective portion, etc.) while wafer growth continues in the other lanes.

In addition, the furnace 30 also may include an alarm module 50 (shown here as part of the controller 47) that generates indicia relating to the wafer fabrication process generally and to the defect detection/removal aspects in particular. For example, the indicia may include such things as an audio signal (e.g., an alarm), a visual signal (e.g., a flashing light or red light), an electronic message to a control console or hand-held device controlled by the operator, and/or a log file. The indicia may include any of a variety of process information, such as, for example, the lane in which a defect was detected, the amount of sheet wafer discarded, the type(s) of defects detected, the severity of the defect(s), the location of defects, the number of defective wafers not removed/discarded, etc.

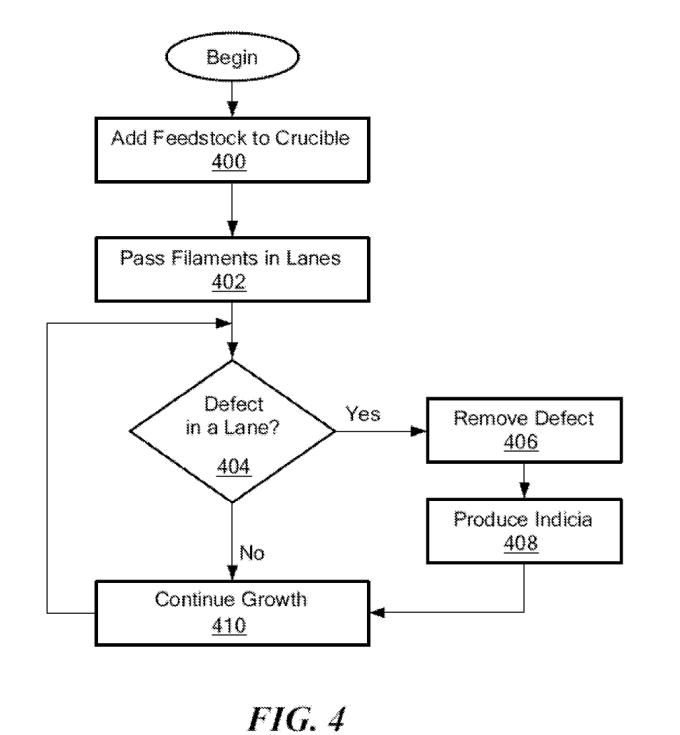

FIG. 4 shows a process of forming a plurality of wafers 10 in the multi-lane furnace 30 in accordance with illustrative embodiments of the invention. It should be noted that for simplicity, this described process is a significantly simplified version of an actual process used to form a plurality of growing sheet wafers 10 in a multi-lane furnace 30. Accordingly, those skilled in the art would understand that the process will have additional steps not explicitly shown in FIG. 4. Moreover, some of the steps may be performed in a different order than that shown, or at substantially the same time (e.g., steps 406 and 408, discussed below). Those skilled in the art should be capable of modifying the process to suit their particular requirements without undue experimentation.

The process begins at step 400, which adds feedstock to the crucible 18. Among other materials, the feedstock may include polysilicon pellets coated with a p-type dopant, such as boron. Next, step 402 passes filaments 28 through the filament openings 26 in the crucible 18 and the polysilicon melt to form a plurality of simultaneously growing sheet wafers 10 across the four lanes. Seeding and other startup techniques known to those skilled in the art also are performed. Both steps 400 and 402 are conventional.

Illustrative embodiments, however, monitor the growing sheet wafers 10 to produce higher quality output wafers 10. Accordingly, step 404 determines if there is a defect in any of the growing sheet wafers 10 of the four lanes. As noted above, conventional vision systems can be programmed to monitor and detect such defects. For example, each lane in the furnace 30 can have a dedicated vision system device (e.g., part of the detect sensors 46) that continually monitors its corresponding sheet wafer 10. Alternatively, a single vision system device can move from lane to lane to detect defects.

If step 404 detects a defect in a given lane (Yes in step 404), the other lanes continue normal operation. The wafer 10 in the given lane, however, is processed to remove the defect (step 406) and/or to produce indicia (step 408) such as a notification to an operator as discussed above. Among other ways, the defect module 48 can automatically cut off and discard a defective portion of the growing wafer 10 having the defect(s), e.g., by controlling the movable assembly 32 and activating the laser assembly 36 to cut off the undesired portion of the growing wafer 10. In preferred embodiments, this portion extends downwardly from the top of the growing wafer 10. Some embodiments stop wafer growth for removing the defect. Other embodiments remove the defective portion while the wafer 10 continues to grow, e.g., removing the defective portion as it would remove a normal wafer 10.

Step 406 may remove the defect if it is isolated to a local portion of the growing wafer 10. After the defective portion (or part of it) is removed, the remaining sheet wafer 10 may be substantially free of defects, or have fewer defects. For example, among other things, step 406 should produce satisfactory results when used to remove a crack 12, break, chip 14, bulge 16, seed junction, or other similar type of defect. When the growing wafer 10 has a significant bow, however, as shown in FIG. 1B, then all or substantially the entire wafer 10 may be removed. In that case, the new wafer 10 to be grown may require reseeding operations.

In addition to, or in lieu of, removing the defect in step 406, the alarm module 50 may produce indicia as discussed above (step 408), e.g., to notify an operator in some manner of relevant process information. After receiving this notification, the operator can take appropriate action, e.g., to locate and fix the source of the defects. For example, the operator can take any of the following remedial actions:
verify alignment of the components,
check vacuum pressures,
verify that the suction cups or other grappling components are not compromised,
run internal test of the system,
confirm that the laser system is aligned and in focus,
ensure that the heat profile of the furnace 30 matches the intended specification,
monitor tension of the filaments 28 passing through the filament openings 26,
determine if the furnace 30 is due for a cleaning,
look for loose or broken debris, such as broken filaments 28, in the melt,
analyze thickness profile of the wafer 10,
confirm that the melt height is neither too high nor too low, and/or
check/adjust the melt temperature.

It should be understood that this list of remedial options is not complete and, thus, the operator may take other remedial steps in response to an alarm condition. Additionally or alternatively, some of these remedial actions may be initiated/performed automatically by the system, e.g., in response to the defect logic 48 or alarm module 50.

Some embodiments do not perform both steps 406 and 408. Instead, some embodiments only remove the defect, while other embodiments only produce the indicia. Some embodiments allow steps 406 and 408 to be selectively performed, e.g., allowing the operator to configure whether one, the other, neither, or both are performed. Thus, at least internally, the system produces an output signal that can be used to drive the alarm module 50 and/or the decision of whether/when/where to remove the defect. In any case, after completing steps 406 and/or 408, normal wafer growth continues in that lane (step 410).

It should be noted that this process may be performed in multiple lanes at the same time. Accordingly, discussion of this process executing in only one lane is not intended to limit all embodiments.

Illustrative embodiments therefore can automatically remove many defects from growing wafers 10 before they are integrated into downstream components, such as photovoltaic cells. This process therefore improves yield of the downstream components, thus reducing overall fabrication costs.

Various embodiments of the invention may be implemented at least in part in a conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, at least part of the disclosed apparatus and methods may be implemented as a computer program product for use with a computer system. Such implementation may include a series of computer instructions fixed either on a tangible medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A method of forming wafer products from a sheet wafer, the method comprising:
melting feedstock material in a crucible that is part of a crystal growth furnace;
passing a plurality of filaments through the crucible to form a sheet wafer;
determining whether a portion of the sheet wafer is defective using an electronic vision system; and
if the portion is deemed to be defective, producing an output signal indicating that the portion is defective.

2. The method as defined by claim 1 wherein determining whether a portion of the sheet wafer is defective comprises at least one of:
determining a defect type for at least one defect in the portion;
determining a defect size for at least one defect in the portion;
determining a defect location for at least one defect in the portion;
determining a defect severity for at least one defect in the portion;
determining a boundary for at least one defect in the portion; and
determining the number of defects within the portion.

3. The method as defined by claim 2 wherein determining a defect type comprises determining whether a defect is one of a bow, a chip, a crack, a break, and a bulge.

4. The method as defined by claim 2 wherein determining a defect location comprises assessing the distance of the defect from at least one edge of the portion.

5. The method as defined by claim 1 wherein the vision system includes a camera for capturing an image of at least the portion of the sheet wafer.

6. The method as defined by claim 1 wherein the vision system includes a sensor for detecting a bow in the portion of the sheet wafer.

7. The method as defined by claim 1 further comprising, in response to the output signal, activating a cutting device to cause removal of the portion from the sheet wafer.

8. The method as defined by claim 7 wherein the cutting device comprises a laser.

9. The method as defined by claim 7, wherein the furnace is a multiple-lane furnace, the sheet wafer in one lane of the furnace, and wherein sheet wafer growth continues in at least one other lane while the portion is removed from the sheet wafer.

10. The method as defined by claim 1 further comprising, in response to the output signal, assessing a level of defectiveness of the portion and grading the portion based on the level of defectiveness.

11. The method as defined by claim 10 further comprising:
sorting the portion based on the grade.

12. The method as defined by claim 1 further comprising, in response to the output signal, producing an indicia.

13. The method as defined by claim 12 wherein the indicia includes at least one of a visual indicia, an audio indicia, and an electronic message.

14. A sheet wafer growth furnace system comprising:
a crucible configured to contain melted feedstock, the crucible having a plurality of holes for passing a plurality of filaments through melted feedstock to form a sheet wafer;
an electronic vision system for producing digital images of a portion of the sheet wafer; and
a controller in communication with the electronic vision system for at least determining whether a portion of the sheet wafer is defective based on the digital images and producing an output signal if the portion is deemed to be defective.

15. The system as defined by claim 14 wherein the controller determines whether the portion is defective based on at least one of:
a defect type for at least one defect in the portion;
a defect size for at least one defect in the portion;
a defect location for at least one defect in the portion;
a defect severity for at least one defect in the portion;
a boundary for at least one defect in the portion; and
the number of defects within the portion.

16. The system as defined by claim 15 wherein a defect type includes at least one of a bow, a chip, a crack, a break, and a bulge.

17. The system as defined by claim 15 wherein determining a defect location comprises assessing the distance of the defect from at least one edge of the portion.

18. The system as defined by claim 14 wherein the vision system includes a camera for capturing an image of at least the portion of the sheet wafer.

19. The system as defined by claim 14 wherein the vision system includes a sensor for detecting a bow in the portion of the sheet wafer.

20. The system as defined by claim 14 further comprising a cutting device that is activated in response to the output signal to cause removal of the portion from the sheet wafer.

21. The system as defined by claim 20 wherein the cutting device comprises a laser.

22. The system as defined by claim 20, wherein the furnace is a multiple-lane furnace, the sheet wafer in one lane of the furnace, and wherein sheet wafer growth continues in at least one other lane while the portion is removed from the sheet wafer.

23. The system as defined by claim 14 wherein the controller is configured to assess the level defectiveness of the portion and grade the portion based on the level of defectiveness in response to the output signal.

24. The system as defined by claim 23 wherein the controller is further configured to sort the portion based on the grade.

25. The system as defined by claim 14 wherein the controller is configured to produce an indicia in response to the output signal.

26. The method as defined by claim 25 wherein the indicia includes at least one of a visual indicia, an audio indicia, and an electronic message.
